(19) United States
(12) Patent Application Publication
(10) Pub. No.: US 2016/0233022 A1
(43) Pub. Date: Aug. 11, 2016

(54) FURNACE TRANSFORMER CAPABLE OF PREVENTING INDUCTION HEAT

(71) Applicant: ILJIN ELECTRIC CO., LTD., Hwaseong (KR)

(72) Inventors: Seong Hyeon Woo, Incheon (KR); Mu Geun Park, Incheon (KR); Hyeong U Lim, Hwaseong (KR)

(73) Assignee: ILJIN Electric CO., LTD., Hwaseong (KR)

(21) Appl. No.: 15/023,031

(22) PCT Filed: Sep. 20, 2014
(86) PCT No.: PCT/KR2014/008760

§ 371 Date: Mar. 18, 2016

(30) Foreign Application Priority Data
Sep. 23, 2013 (KR) 10-2013-0112912

(51) Int. Cl. H01F 27/36; H01F 27/04; H01F 27/28; H01F 30/12

(52) U.S. Cl. CPC H01F 27/365; H01F 30/12; H01F 27/04; H01F 27/2828

(57) ABSTRACT

Disclosed is a furnace transformer, which is capable of preventing induction heating by using an integrated insulating plate and paramagnetic shield plate. The furnace transformer, in which bushings of a plurality of phases is drawn out to the outside, includes an insulating plate configuring a partial surface of an external side of the furnace transformer, and all of the bushings of the plurality of phases are installed while passing through the insulating plate. According to the furnace transformer according to the present invention may maximally suppress induction heating generated on a surface of a tank adjacent to a secondary side and minimize an overall size of the furnace transformer.

### TECHNICAL FIELD

The present invention relates to a furnace transformer, which is capable of preventing induction heating, and more particularly, to a furnace transformer, which is capable of preventing induction heating by using an integrated insulating plate and paramagnetic shield plate.

### BACKGROUND ART

A furnace transformer is a special transformer supplying power to furnace equipment used in a manufacturing process of steel, alloys, or nonferrous metals, and a secondary side thereof requires a high current according to a process characteristic.

In general, since a predetermined degree of leakage flux is generated in winding wires, internal connection leads, and bushings at a secondary side in a transformer, and a tank forming an external side of the transformer is formed of a magnetic substance, induction heating is generated in a surface of the tank adjacent to the winding wires, the internal connection lead, and the bushings at the secondary side by the leakage flux. By reason of the induction heating, a temperature of the surface of the tank adjacent to the secondary-side element is increased, so that it is necessary to control the induction heating.

However, the furnace transformer has a characteristic in that a high current is applied to the secondary side, so that a relatively larger induction heating phenomenon is generated compared to that of the general transformer, and thus a surface of the tank adjacent to the secondary-side element has a relatively high temperature. When the tank has a high temperature, insulation performance is degraded due to deterioration of insulating oil and insulating paper, so that an insulation accident is generated, or a problem in safety, such as a fire danger, is generated. Accordingly, in order to avoid the induction heating, the surface of the tank needs to be far spaced apart from the secondary-side element, and thus an overall size of the transformer is increased.

Accordingly, in order to prevent an insulating accident and achieve a small size of the furnace transformer, it is necessary to maximally suppress induction heating generated on a surface of the tank adjacent to the secondary side.

### DETAILED DESCRIPTION OF THE INVENTION

### Technical Problem

An object to be solved in the present invention is to provide a furnace transformer, which is capable of maximally suppress induction heating generated in a surface of a tank adjacent to a secondary-side and decreasing an overall size of the furnace transformer.

Objects of the present invention are not limited to the objects described above, and other objects that are not described will be clearly understood by a person skilled in the art from the description below.

### Technical Solution

An exemplary embodiment of the present invention provides a furnace transformer, in which bushings of a plurality of phases is drawn out to the outside, the furnace transformer including: an insulating plate configuring a partial surface of an external side of the furnace transformer, in which all of the bushings of the plurality of phases are installed while passing through the insulating plate.

The insulating plate may be formed of an epoxy material.

The insulating plate may be connected with and fixed to a tank main body made of a magnetic material, and a paramagnetic shield plate may be installed so as to be in contact with an internal surface of the tank main body.

The paramagnetic shield plate and the tank main body may be fixed by fastening large-area nuts, which has a larger lower-side contact area than lower-side contact areas of a hexagonal nut and a square nut according with the KS standard, and bolts fixed to the external tank.

### Advantageous Effects

According to the furnace transformer according to the present invention, it is possible to maximally suppressing induction heating generated in a surface of a tank adjacent to a secondary side, thereby decreasing an overall size of the furnace transformer.

### BRIEF DESCRIPTION OF DRAWINGS

FIG. 1A is a schematic perspective view of a tank surface module around bushings of a furnace transformer of the present invention.

FIG. 1B is a schematic perspective view of the tank surface module of FIG. 1A viewed at a different angle.

FIG. 1C is a schematic front view of FIG. 1B.

FIG. 2A is a schematic front view of a comparative example, in which a magnetic substance made of the same material as that of a tank main body is disposed between bushings of respective phases.

FIG. 2B is a schematic front view of the tank surface module of FIG. 1A.

FIGS. 3A to 3F are temperature simulation data of a tank part having the configuration of FIG. 2A according to an interval between an internal connection lead and the tank.

### BEST MODE

In order to solve the aforementioned problems, a furnace transformer, in which bushings of a plurality of phases is drawn out to the outside, includes an insulating plate configuring a partial surface of an external side of the furnace transformer, and all of the bushings of the plurality of phases are installed while passing through the insulating plate.

### MODE FOR CARRYING OUT THE INVENTION

Various advantages and features of the present disclosure and methods accomplishing thereof will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention. Therefore, the present invention will be defined only by the scope of the appended claims.

Although “a first . . . ”, a second . . . ”, and the like, are used for describing various constituent elements, but it is apparent that the constituent elements are limited by the terms. The terms are simply used for discriminating one constituent element from another constituent element. Accordingly, a first constituent element referred below may be a second constituent element within the technical spirit of the present invention.

In using reference numerals in the present specification, when the same configuration is illustrated even in the different drawings, the same reference numeral is used.

A size and thickness of each configuration illustrated in the drawings are illustrated for convenience of description, and the present invention is not essentially limited to the size and the thickness of the illustrated configuration.

Hereinafter, exemplary embodiments of a furnace transformer of the present invention will be described with reference to the accompanying drawings.

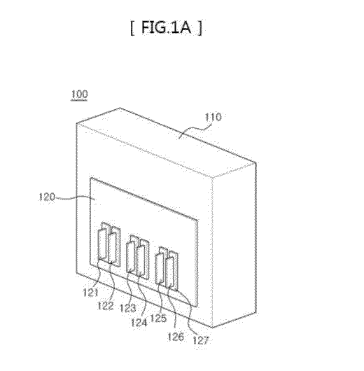

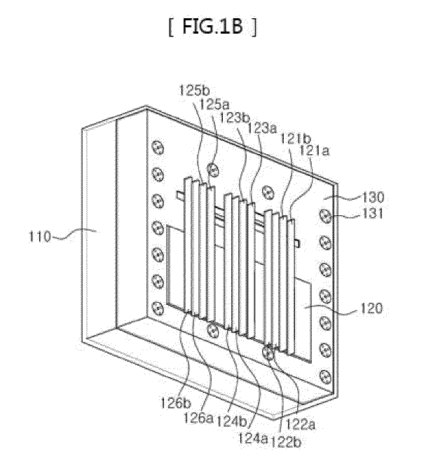

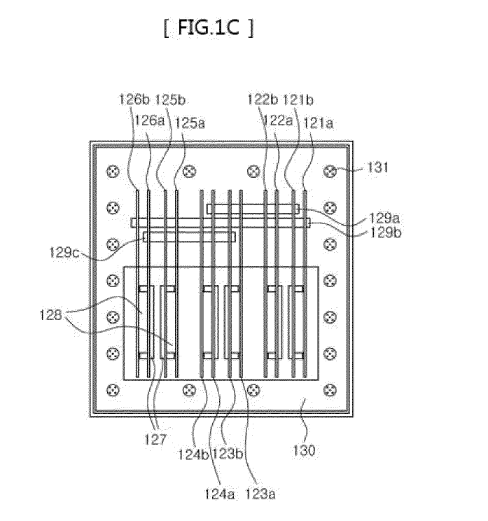

FIG. 1A is a schematic perspective view of a tank surface module around bushings of a furnace transformer of the present invention, FIG. 1B is a schematic perspective view of the tank surface module of FIG. 1A viewed at a different angle, and FIG. 1C is a schematic front view of FIG. 1B.

The furnace transformer is configured so that bushings 121 to 126 are drawn out from an internal side to an external side of an external tank, and in the present exemplary embodiment, the configurations other than FIGS. 1A to 1C are the same as those of a general furnace transformer, so that detailed descriptions of the remaining parts will be omitted. Hereinafter, a tank surface module 100 around the bushings 121 to 126 of the furnace transformer will be described in detail with reference to FIGS. 1A and 1C.

Further, in the present specification, the furnace transformer having three phases including U-shaped bushings 121 and 122, V-shaped bushings 123 and 124, and W-shaped bushings 125 and 126 is described as an example, and thus the furnace transformer of the present invention includes the bushings of all of the three phases.

Further, in the present specification, it is described that the tank surface module 100 is separate from other parts of the tank configuring an external side of the furnace transformer and is formed in a separate module, but this is for convenience of description, and a tank main body 110 to be described below may also be integrally formed with other parts of the tank without being separated from other parts of the tank.

Referring to FIGS. 1A, 1B, and 1C, the tank surface module 100 around the bushings of the furnace transformer of the present invention includes the tank main body 110, an insulating plate 120, and a paramagnetic shield plate 130.

The tank main body 110, which is a part formed of the same material as that of the tank configuring the external side of the furnace transformer, may be formed of a metal material containing steel, for example, metal of SS4000 or STS304 that is structure steel, in order to improve strength for sufficiently protecting internal components (for example, internal leads and winding wires) of the furnace transformer from the outside. In the exemplary embodiment illustrated in FIGS. 1A to 1C, the tank main body 110 is formed in a box shape so that the tank surface module 100 is separated from the external tank and is formed in a module, but this is for illustrative, and the tank main body 110 may be integrally formed with the external tank.

In the meantime, the tank main body 110 includes steel for strength and thus forms a magnetic substance. Accordingly, the tank main body 110 is inductively heated by leakage flux at a secondary side of the furnace transformer, so that a surface temperature thereof may be increased. Hereinafter, a structure capable of minimizing induction heating will be described.

Referring to FIGS. 1A to 1C, the tank main body 110 is provided with an opening, which is opened at a center portion of the tank main body 110, and the insulating plate 120 is fixedly installed at the tank main body 110 so as to close the opening. That is, the insulating plate 120 forms a partial surface of the external side of the furnace transformer.

All of the three-phase bushings 121 to 126 are installed in the insulating plate 120 while passing through the insulating plate 120. That is, the insulating plate 120 is integrally formed of one plate so that the insulating plate 120 is also positioned between the respective bushings 121 to 126.

The insulating plate 120 may be formed of a material, for example, a resin material including an epoxy material, which is not inductively heated by leakage flux. The insulating plate 120 may be formed in a size as large as possible in an aspect of preventing induction heating, but strength of the insulating plate 120 is lower than that of the tank main body 110, so that it is impossible to unlimitedly increase the size of the insulating plate 120, and the size of the insulating plate 120 may be determined within a range, in which the bushings 121 to 126 may be sufficiently fixed and be sufficiently endured from external impact and the like.

In the meantime, every one pair of the bushings 121 to 126 is drawn to the outside per phase, and the insulating plate 120 may be positioned even between the bushings of the same phase. That is, it is preferable that the magnetic substance, such as the tank main body 110, is not positioned between the bushings 121 to 126. Further, a packing 127 formed of an elastic material, such as rubber, may be inserted between the bushings 121 to 126 and the insulating plate 120 in order to prevent leakage of insulating oil inside the furnace transformer.

Referring to FIG. 1B, the paramagnetic shield plate 130 is installed to be in contact with an inner surface of the tank main body 110. The paramagnetic shield plate 130 has an effect of reflecting leakage flux, thereby releasing induction heating of the tank main body 110 that is the magnetic substance. For reference, in FIG. 1B, for convenience of the description, the illustration of bent portions of the tank main body 110 at an upper side and a right side is omitted.

In general, a silicon steel plate having a characteristic of attracting magnetic flux is used for shielding leakage flux, and the silicon steel plate has directionality, so that the silicon steel plate needs to be arranged in accordance with a direction, in which the leakage flux is generated. Accordingly, the leakage flux is formed in multiple directions, a shield effect of the silicon steel plate is degraded, and further, a fringing effect is generated in an inevitably generated fine crack, so that a heating phenomenon is concentrated to a corresponding space. By contrast, the paramagnetic shield plate 130 has a characteristic of reflecting magnetic flux regardless of a direction of the magnetic flux, so that the paramagnetic shield plate 130 is suitable to handle leakage flux in multiple directions, and may prevent a heating phenomenon by the fringing effect from being concentrated.

The paramagnetic shield plate 130 may be made of a material, that is, aluminum and copper, having a paramagnetic property. A thickness of the paramagnetic shield plate 130 may be various set according to a design.

The paramagnetic shield plate 130 may be fixedly installed on the internal surface of the tank main body 110 as close as possible. The paramagnetic shield plate 130 may be fixed to the internal surface of the tank main body 110 by welding and the like, and may be fixed by fastening large-area nuts 131 to ends of bolts (not illustrated) passing through the paramagnetic shield plate 130. Accordingly, the large-area nuts 131 enable the paramagnetic shield plate 130 to be closely fixed to the tank main body 110, and a diameter of the large-area nut 131 may be large as possible as it can.

Particularly, a diameter of the large-area nut 131 may be set to be larger than that of a nut having a general standard. As an accurate standard, a lower-side contact area of the large-area nut 131 may be set to be larger than lower-side contact areas of a hexagonal nut and a square nut according with the KS standard. Here, the KS standard of the hexagonal nut is in accordance with the KS B 1012, and the KS standard of the square nut is in accordance with the KS B 1013.

When a nut of a general standard, such as the 35KS standard, is used, the lower-side contact area of the nut is small, so that the paramagnetic shield plate 130 is not evenly in contact with the tank main body 110, and thus induction heating preventing performance is degraded. By contrast, when the large-area nut 131 is used, the paramagnetic shield plate 130 is evenly in contact with the tank main body 110, so that it is possible to expect better induction heating preventing performance.

In the meantime, four holes are formed at an upper side of the large-area nut 131, so that the four holes may be used when the large-area nut 131 is fixed to the bolt fixed to the tank main body 110. Further, the large-area nuts 131 may be distributed on the paramagnetic shield plate 130 at an equal interval. Further, when the large-area nut 131 is formed of a paramagnetic substance, it is possible to prevent induction heating by leakage flux.

Referring to FIG. 1C, each of the bushings 121 to 126 is divided into a pair of leads 121a and 121b to 126a and 126b by a connection part 128 inside thereof. For example, the bushing 121 is divided into a lead 121a and a lead 121b inside thereof

Busbar plates 129a, 129b, and 129c are used for an internal connection between the bushings of each phase, and electrically connect the bushings of each phase and internally connect the bushings. In the present exemplary embodiment, a delta connection is exemplified, and the busbar plate 129a connects the U-phase bushings 121 and 122 and the V-phase bushings 123 and 124, the busbar plate 129b connects the U-phase bushings 121 and 122 and the W-phase bushings 125 and 126, and the busbar plate 129c connects the V-phase bushings 123 and 124 and the W-phase bushings 125 and 126. However, the connection may be performed by other publicly known connection methods.

Hereinafter, an effect of the tank surface module 100 of the present exemplary embodiment will be described through an interpretation of a temperature.

First, an effect of the insulating plate 120 will be described.

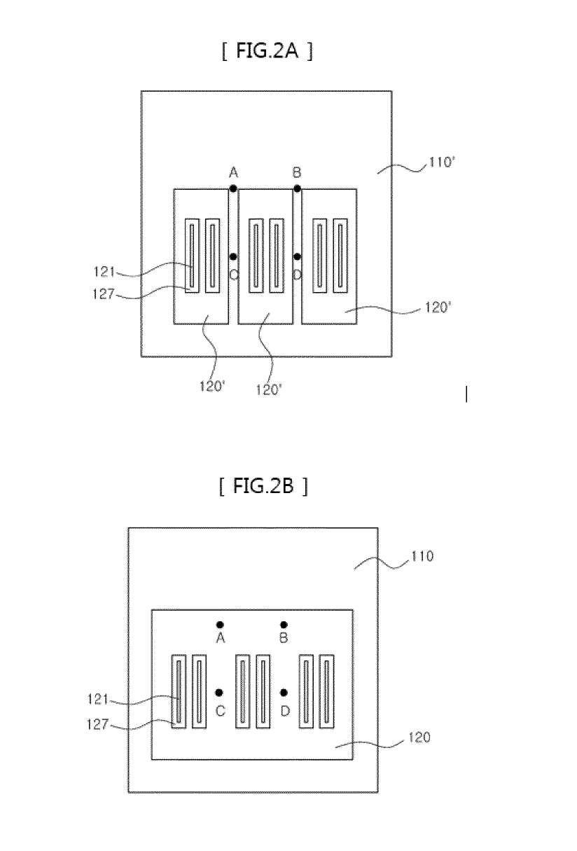

FIG. 2A is a schematic front view of a comparative example, in which a magnetic substance made of the same material as that of the tank main body is disposed between the bushings of the respective phases, and FIG. 2B is a schematic front view of the tank surface module of FIG. 1A.

The comparative example of FIG. 2A has the same configuration as that of the present exemplary embodiment, except that an insulating plate 120′ is divided into three insulating plates and disposed at bushings of respective phases. That is, in FIG. 2A, a space between the respective insulating plates 120′ is formed of a magnetic substance. Further, external conditions, such as a distance from a secondary winding wire and an internal connection, are also equally set. For reference, in the experiment, a secondary-side constant current was set as 50,000 A, and mineral oil was used as an internal insulating medium.

A temperature was measured at points A, B, C, and D illustrated in FIGS. 2A and 2B, and a result thereof is represented in the table below.

TABLE 1

| | Temperature | Temperature | Temperature | Temperature |
|---|---|---|---|---|
| | at point A | at point B | at point C | at point D |
| | (° C.) | (° C.) | (° C.) | (° C.) |
| Comparative | 112 | 90 | 64.5 | 52 |
| Example | | | | |
| (FIG. 2A) | | | | |
| Exemplary | 26.9 | 25 | 28 | 25.8 |
| Embodiment | | | | |
| (FIG. 2B) | | | | |
| Deviation | 85.1 | 65 | 36.5 | 26.2 |

As represented in Table 1, it can be seen that in the present exemplary embodiment, the magnetic substance is heated to 25 to 28° C. with little temperature deviation at each point. By contrast, it can be seen that in the comparative example of FIG. 2A, a temperature deviation at each point is a maximum of 60° C., which is large, and a temperature deviation at each point between the comparative example and the exemplary embodiment is a maximum of 85.1° C., so that the magnetic substance part is heated to a considerably high temperature.

Based on the experiment result, it can be seen that it is possible to stably control a temperature around the bushing within a range of 25 to 28° C. through the integrally formed insulating plate 110 as illustrated in FIGS. 1A to 1C, so that an overall size of the furnace transformer may be decreased.

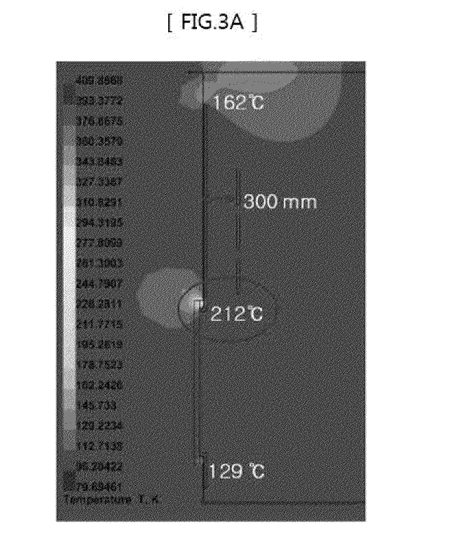

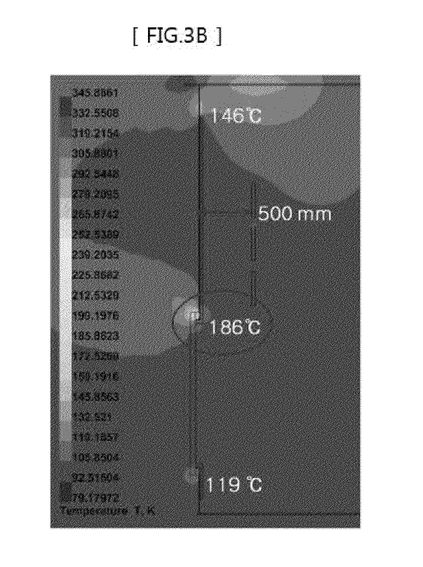

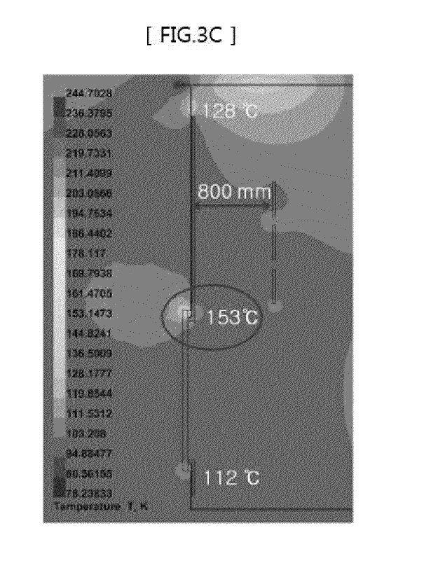

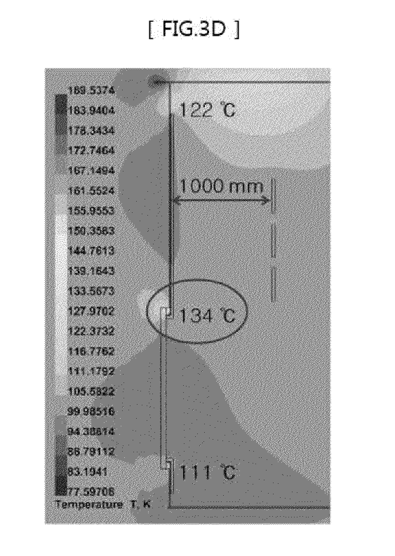

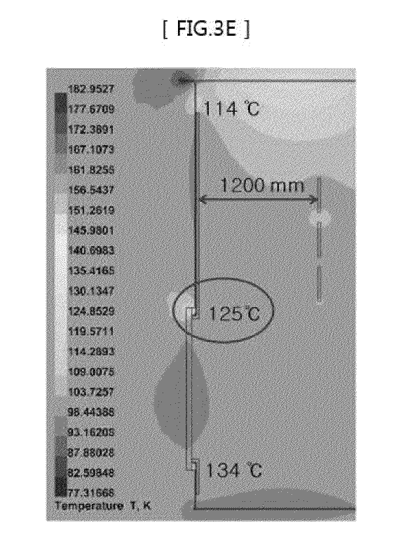

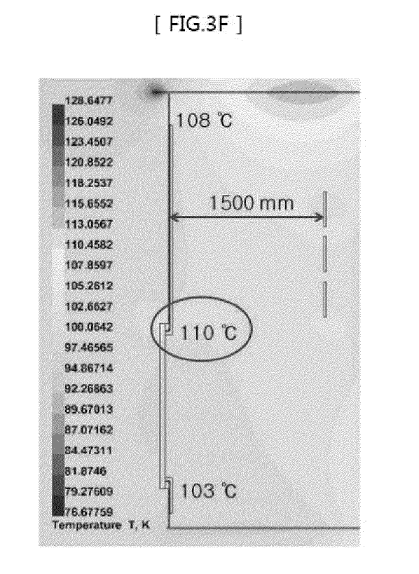

FIGS. 3A to 3F are temperature simulation data of a tank part having the configuration of FIG. 2A according to an interval between the internal connection lead and the tank.

As a simulation condition, a secondary-side constant current is set to about 50,000 A, a material of the tank in a corresponding portion is STS304, an insulating medium inside the tank is set as mineral oil, and a silicon steel plate is applied to the inside of the tank. The simulation was performed by “H lead” software of the VIT Company.

The simulation was performed by setting the interval between the internal connection lead and the tank as 300 mm, 500 mm, 800 mm, 1,000 mm, 1,200 mm, and 1,500 mm, and a result of the simulation is illustrated in FIGS. 3A to 3F.

Referring to FIGS. 3A to 3F, it can be seen that when an interval between the internal connection lead and the tank is 300 mm, a temperature of the tank surface is increased to 212° C., when an interval between the internal connection lead and the tank is 500 mm, a temperature of the tank surface is increased to 186° C., when an interval between the internal connection lead and the tank is 800 mm, a temperature of the tank surface is increased to 153° C., when an interval between the internal connection lead and the tank is 1,000 mm, a temperature of the tank surface is increased to 134° C., when an interval between the internal connection lead and the tank is 1,200 mm, a temperature of the tank surface is increased to 125° C., and when an interval between the internal connection lead and the tank is 1,500 mm, a temperature of the tank surface is increased to 110° C.

According to the International Electrotechnical Commission (IEC) standard, an allowance value of a temperature of a tank of a transformer is 140° C., so that it is necessary to secure an interval of a minimum of 1,000 mm between the internal connection lead and the tank.

By contrast, according to the configuration of the exemplary embodiment of FIGS. 1A to 1C, it was found that even if an interval between the internal lead and the tank is small, a temperature of the insulating plate 120 is not increased, and even though only an internal of about 225 mm is secured, a temperature of the insulating plate surface does not exceed 30° C. as the result of the experiment.

As described above, it is possible to minimize induction heating by the configurations of the insulating plate 120 and the paramagnetic shield plate 130, and thus it is possible to minimize an interval between the internal connection lead and the tank. Particularly, compared to the result of the simulation (FIGS. 3A to 3F) according to the configuration of the comparative example of FIG. 2A, an interval between the internal connection lead and the tank may be decreased by about 77.5%. Accordingly, it is possible to provide the furnace transformer, which stably comply with the IEC standard and has a minimized size.

The exemplary embodiments of the present invention have been described with reference to the accompanying drawings, but those skilled in the art will understand that the present disclosure may be implemented in another specific form without changing the technical spirit or an essential feature thereof. Thus, it is to be appreciated that embodiments described above are intended to be illustrative in every sense, and not restrictive.

1. A furnace transformer, in which bushings of a plurality of phases are drawn out to the outside, the furnace transformer comprising:
an insulating plate configuring a partial surface of an external side of the furnace transformer,
wherein all of the bushings of the plurality of phases are installed while passing through the insulating plate.

2. The furnace transformer of claim 1, wherein the insulating plate is formed of an epoxy material.

3. The furnace transformer of claim 1, wherein the insulating plate is connected with and fixed to a tank main body made of a magnetic material, and a paramagnetic shield plate is installed so as to be in contact with an internal surface of the tank main body.

4. The furnace transformer of claim 3, wherein the paramagnetic shield plate and the tank main body are fixed by fastening large-area nuts, which has a larger lower-side contact area than lower-side contact areas of a hexagonal nut and a square nut according with the KS standard, and bolts fixed to the tank main body.
